(19) United States
(12) Patent Application Publication
(10) Pub. No.: US 2010/0057231 A1
(43) Pub. Date: Mar. 4, 2010

(54) AUDIO WATERMARKING APPARATUS AND METHOD

(75) Inventors: Christopher Slater, Farnborough (GB); Stephen Mark Keating, Reading (GB); Mark Julian Russell, Maidenhead (GB)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/482,637

(22) Filed: Jun. 11, 2009

(30) Foreign Application Priority Data
Sep. 1, 2008 (GB) 0815889.1

(51) Int. Cl. G06F 17/00

(52) U.S. Cl. 700/94

(57) ABSTRACT

An apparatus for embedding a watermark in an audio signal, the apparatus comprising:
an input operable to receive the audio signal;
a watermark adapting unit operable to receive the watermark from a watermark generating unit and adapt the profile of the frequency spectrum of the watermark to correspond to the profile of the frequency spectrum of the input audio signal, and
watermark embedding means operable to embed the adapted watermark in the audio signal, the watermark embedding means including a watermark gain amplifier operable to apply a gain to the watermark before the watermark is embedded in the audio signal in accordance with a gain signal generated by a watermark gain value generator, wherein
the watermark gain value generator is operable to adjust the gain applied to the watermark, the gain being determined in accordance with the presence of component of at least one peak having an amplitude above a threshold is described

### BACKGROUND OF THE INVENTION

1. Field of the Invention

The present invention relates to audio watermarking apparatus and method.

2. Description of the Prior Art

The Digital Cinema Initiative (DCI) is a known project which aims to provide an open standard for digital cinema. The standard covers many aspects of digital cinema including implementing security measures to hinder unauthorised copying, editing and playback of cinematic content.

One of the security requirements used in the DCI is the insertion of a watermark in the audio data of the content during projection. The audio watermark includes a time stamp and other data, for example information indicating the identity of the system on which the cinematic content is being reproduced. In the same way that a visually obvious watermark inserted into the video data is undesirable, an audio watermark which is audible is also undesirable. Therefore the DCI standard sets out strict requirements for the audio watermark amongst which are that the audio watermark must be inaudible in critical listening A/B tests.

Some adaptive watermarking systems can struggle to successfully mask the presence of a watermark in an audio signal if the audio signal contains prominent frequency components over a narrow range of frequencies. This is caused by inevitable signal spreading within the system due to non-ideal filtering. Such watermarking systems may not meet the requirements set out in the DCI standard for the audibility of audio watermarks. Increasing the number and resolution of the audio filters present within the watermarking system could potentially address this problem. However, this would increase the cost and complexity and may in itself introduce unwanted filter artefacts into the embedded watermark. This problem is addressed by embodiments of the invention.

### SUMMARY OF THE INVENTION

According to the present invention there is provided an apparatus for embedding a watermark in an audio signal, the apparatus comprising an input operable to receive the audio signal; a watermark adapting unit operable to receive the watermark from a watermark generating unit and adapt the profile of the frequency spectrum of the watermark to correspond to the profile of the frequency spectrum of the input audio signal, and watermark embedding means operable to embed the adapted watermark in the audio signal, the watermark embedding means including a watermark gain amplifier operable to apply a gain to the watermark before the watermark is embedded in the audio signal in accordance with a gain signal generated by a watermark gain value generator, wherein the watermark gain value generator is operable to adjust the gain applied to the watermark, the gain being determined in accordance with the presence of component of at least one peak having an amplitude above a threshold.

The present invention identifies problematic parts of the audio signal which are likely to cause signal spreading outside of the masking limits of the human auditory system and thus increase the audibility of the watermark and, in response, adjust the watermark gain for the duration of the problematic parts. Thus, in parts of the audio signal where a conventional watermarking system would struggle to mask an embedded watermark, the apparatus and method according to the present invention reduces the watermark's audibility. As a further advantage, as the nature of cinematic audio content is such that the occurrence of prominent frequency components over a narrow range of frequencies is usually quite rare. Therefore any reduction in watermarking robustness due to the low level of the watermark is minimised as the reduction in the watermark level is only temporary.

The frequency range of the or each peak may be such that the peak would cause spreading in the input audio signal such that the watermark in the watermark embedded audio signal is audible to the human ear and if such a peak or peaks are detected, the watermark gain value generator may be operable to modify the gain signal such that the gain applied to the watermark by the watermark gain amplifier is reduced.

The apparatus may further comprise a plurality of envelope filters, each filter being operable to receive the input audio signal and to output an envelope signal corresponding to the distribution of energy across a subset of the frequency spectrum of the input audio signal, each subset being different for each filter.

The gain signal may be determined by a predetermined gain curve, the gain curve defining the gain signal in dependence of the frequency at which the amplitude of the component peak is largest.

The transition from a first value of gain signal to a second value of gain signal may be made incrementally, each increment being of a predetermined value and a predetermined length of time in duration.

The increments may be one of either a stepped increment or a gradational increment.

The watermark gain value generator may further be operable to determine the gain in accordance with a comparison between the energy contained in the peak or peaks above the threshold and the energy in the input audio signal.

According to a further aspect, there is provided a digital cinema projector comprising a decoder for decoding audio data from a data source; a watermarking apparatus according to any embodiment of the invention for inserting a watermark into the audio data; and a unit for outputting the watermarked audio data.

According to another aspect, there is provided a method of embedding a watermark in an audio signal, the method comprising: receiving the audio signal; receiving the watermark from a watermark generating unit and adapting the profile of the frequency spectrum of the watermark to correspond to the profile of the frequency spectrum of the input audio signal, and embedding the adapted watermark in the audio signal, wherein, before embedding in the audio signal, a gain is applied to the watermark before the watermark is embedded in the audio signal in accordance with a gain signal, wherein the gain is determined in accordance with the presence of component of at least one peak having an amplitude above a threshold.

The frequency range of the or each peak may be such that the peak would cause spreading in the input audio signal such that the watermark in the watermark embedded audio signal is audible to the human ear and if such a peak or peaks are detected, the gain signal is modified such that the gain applied to the watermark is reduced.

A plurality of envelope filters may be provided, each filter being operable to receive the input audio signal and to output an envelope signal corresponding to the distribution of energy across a subset of the frequency spectrum of the input audio signal, each subset being different for each filter.

The gain signal may be determined by a predetermined gain curve, the gain curve defining the gain signal in dependence of the frequency at which the amplitude of the component peak is largest.

The transition from a first value of gain signal to a second value of gain signal may be made incrementally, each increment being of a predetermined value and a predetermined length of time in duration.

The increments may be one of either a stepped increment or a gradational increment.

The gain may be determined in accordance with a comparison between the energy contained in the peak or peaks above the threshold and the energy in the input audio signal.

Various further aspects and features of the invention are defined in the appended claims.

### BRIEF DESCRIPTION OF THE DRAWINGS

The above and other features and advantages of the invention will be apparent from the following detailed description of illustrative embodiments which is to be read in connection with the accompanying drawings and in which:

FIG. 1 provides a schematic diagram of a cinema system which allows the audio stream to have a watermark to be embedded;

FIG. 2 provides a schematic diagram showing a watermarking unit;

FIG. 3 provides a schematic diagram illustrating the frequency spectrum of various signals being processed by the watermarking unit shown in FIG. 2;

FIG. 4 provides a schematic diagram illustrating the frequency spectrum of various signals being processed by the apparatus shown in FIG. 1 where the audio data unit contains prominent frequency components over a narrow range of frequencies;

FIG. 5 provides a schematic diagram of a watermarking unit arranged in accordance with embodiments of the present invention;

FIG. 6 provides a schematic diagram illustrating the frequency spectrum of various signals undergoing a gating process in embodiments of the present invention;

FIG. 7 illustrates an example gain reduction curve used in the watermarking unit of FIG. 5;

FIG. 8 illustrates another example gain reduction curve which is used in the watermarking unit of FIG. 5;

FIG. 9 illustrates a change in gain which comprises a series of discrete stepped values;

FIG. 10 illustrates some example smoothing interpolations of the gain change output according to embodiments of the present invention;

FIG. 11 provides a schematic diagram showing part of a three stage pipeline according to an embodiment of the present invention; and

FIG. 12 provides a summary of the steps included in the implementation of embodiments of the present invention.

### DESCRIPTION OF EXAMPLE EMBODIMENTS

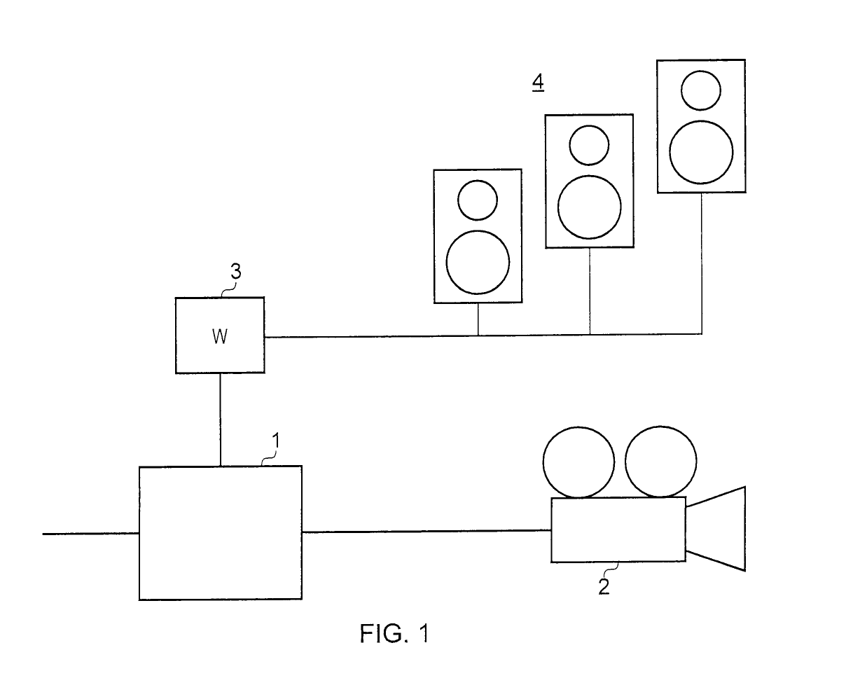

FIG. 1 provides a schematic diagram of a cinema system which allows the audio stream to have a watermark to be embedded. A decoder 1 extracts audio data and video data from a data source (not shown). The video data is sent to a projection unit 2 for further processing, for example the adding of a video watermark, and then projection. The extracted audio data is sent to watermarking unit 3. The audio signal sent to the watermarking unit 3 is divided into units of a predetermined duration. The duration of the audio units may for example be approximately 170 ms formed from a block of 8192 samples, sampled at 48 kHz. Each unit of audio data is processed sequentially and has a watermark added to it. The watermarked audio data is then sent to a sound system 4 which outputs the audio data as sound.

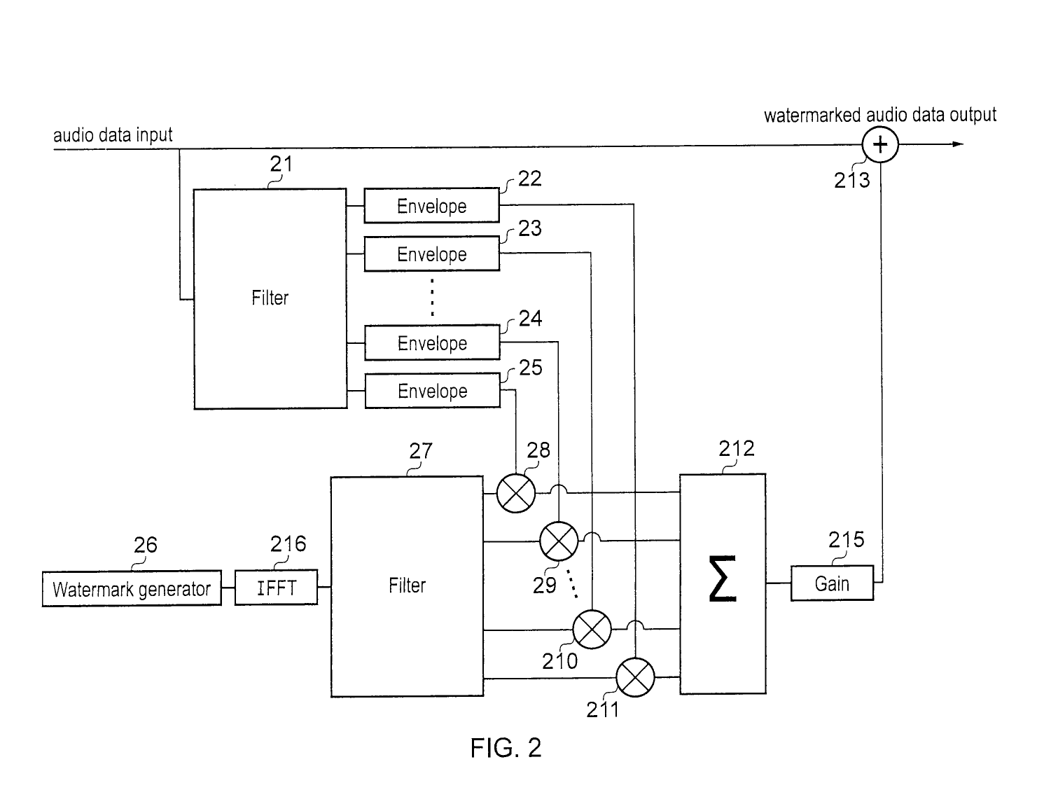

FIG. 2 provides a schematic diagram showing the watermarking unit 3 in more detail. The watermarking unit 3 is arranged such that before a watermark is added to the audio signal, the watermark is adapted with respect to the audio data to reduce its perceptibility when it is embedded in the audio data.

In the watermarking unit shown in FIG. 2, the input audio data may be in the form of blocks of input audio data of a predetermined length as described above. Each input audio block is sent to a first band filter 21 which divides the block into a number of frequency bands and outputs a corresponding number of band divided blocks. Each band divided block represents the energy within a particular frequency band range. In an illustrative example, the input audio block is band filtered into 16 bands ranging from around 160 Hz to 5kHz. The watermarking unit 3 also includes a number of envelope follower filters 22, 23, 24, 25. Each band divided signal output by the first band filter 21 is input to one of the envelope follower filters 22, 23, 24, 25. As will be understood, the number of envelope follower filters corresponds to the number of output band divided blocks. Each envelope follower filter is configured to provide an output signal which represents the energy within each corresponding band divided block.

A watermark generator 26 generates a watermark signal in the frequency domain which is then transformed into the time domain by an inverse FFT unit 216 and input to a second band filter 27. In an illustrative example the watermark is a pseudo-random Gaussian stream created in the fast Fourier Transform (FFT) domain with a block size of 2048 at quarter sampling rate (i.e. a quarter of the rate at which the audio is sampled), which is noise like in sound. Once the watermark has been generated in the frequency domain, it is then transformed into the time domain by the inverse FFT unit 216. In one embodiment, the watermark generator receives an FFT of the audio input block and uses an FFT of the audio input block to provide phase values and the watermark to provide magnitude values and the combination is input into the inverse FFT unit 216. The result can then be added to the input audio block in the time domain, thus reducing any potential loss in quality of the audio caused by putting the audio input through a forward FFT and then inverse FFT. The second band filter 27 operates in a similar way to the first band filter 21 and divides the watermark signal into a number of band blocks and outputs a corresponding number of band divided watermark blocks. The frequency bands into which the watermark signal is divided correspond to the frequency bands into which the input audio block is divided. Next, a number of multipliers 28, 29, 210, 211 multiply the output from each envelope follower filter 22, 23, 24, 25 with the corresponding band divided part of the watermark signal output from the second band filter 27. The outputs of the multipliers 28, 29, 210, 211 are then added together by a first combiner 212 which thus forms the complete adapted watermark. The output of the first combiner 212 is then multiplied by a gain amplifier 215 and combined with the input audio block of the original audio data by a second combiner 213. Typically, all the operations occur in the time domain. Thus the watermarked version of the original audio data unit is formed.

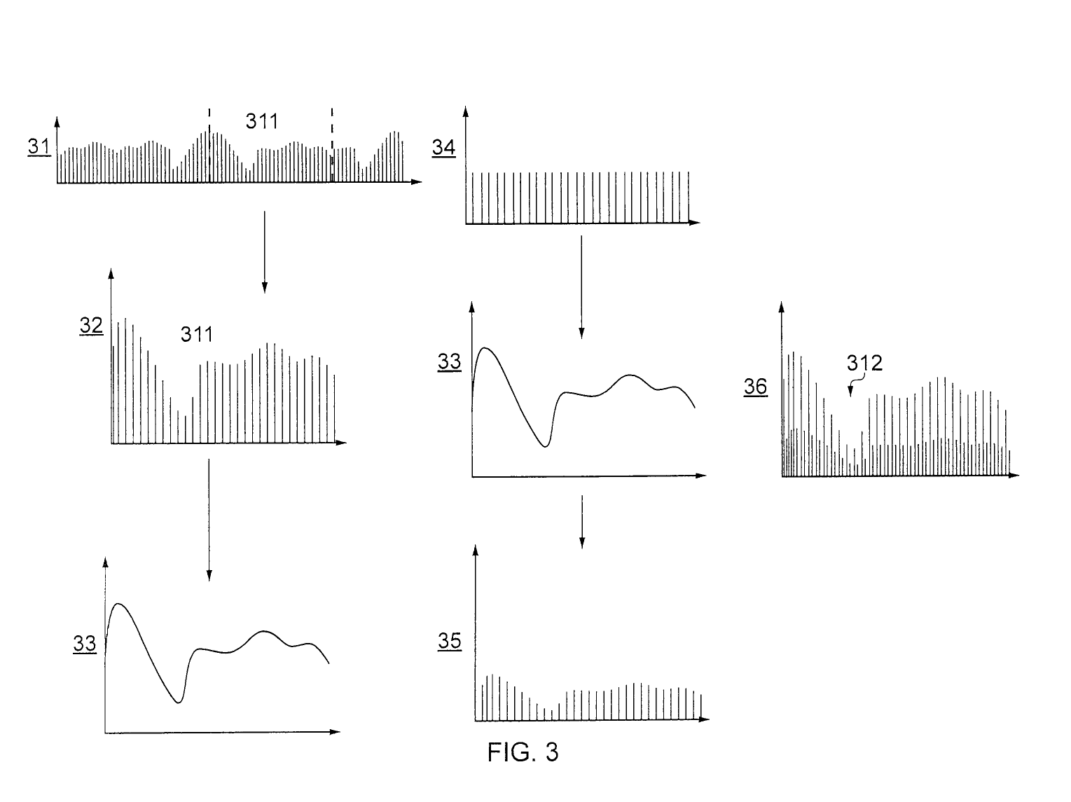

The multiplication of each band divided block of the watermark signal with the output of the corresponding envelope filtered band of the input audio block has the effect of reducing the perceptibility of the watermark when it is combined with the original audio data. This is illustrated in FIG. 3 which shows the frequency spectrum of various signals being processed by the watermarking unit shown in FIG. 2. FIG. 3 includes a first graph 31 showing a portion of the frequency spectrum of the input audio block. The part 311 of the audio block frequency spectrum between the dotted lines represents one of the bands into which the band filter 21 divides the audio data block. A second graph 32 shows the corresponding band divided portion 311 of the input audio block after it has been filtered by the first band filter 21. The band divided block 32 is input into one of the envelope filters 22, 23, 24, 25. A third graph 33 shows the frequency spectrum of the output of the envelope filter which illustrates the distribution of energy across the frequency spectrum of the band divided block shown in the second graph 32. A fourth graph 34 shows the frequency spectrum of a portion of the band divided watermark block output by the second band filter 27. The time domain multiplication of the band divided block of the watermark 34 with the output of the corresponding envelope filter results in a signal with a frequency spectrum as shown in a fifth graph 35. As the fifth graph shows, the frequency spectrum of the band divided watermark block has been adapted such that it corresponds to the profile of the frequency spectrum of the envelope filter 33. A sixth graph 36 shows in the frequency domain the result of the combination of the adapted portion of the watermark and the band divided portion of the audio signal. As can be seen, the profile of the frequency spectrum of the adapted portion of the watermark block is similar to that of the band divided block of the audio data. The Human Auditory System (HAS) has a certain level of overlap in its spectral response, whereby the perception of a frequency can be masked by another nearby frequency if it is greater in level. Therefore, by adapting the watermark so that the profile of its frequency spectrum corresponds to that of the audio data unit, the audibility and thus perceptibility of the watermark when it is embedded in the audio data unit is reduced. For example, at point 312 on the sixth graph 36, the level of the frequency spectrum of the watermark has been reduced to accommodate for a corresponding drop in the level of the frequency spectrum of the audio signal.

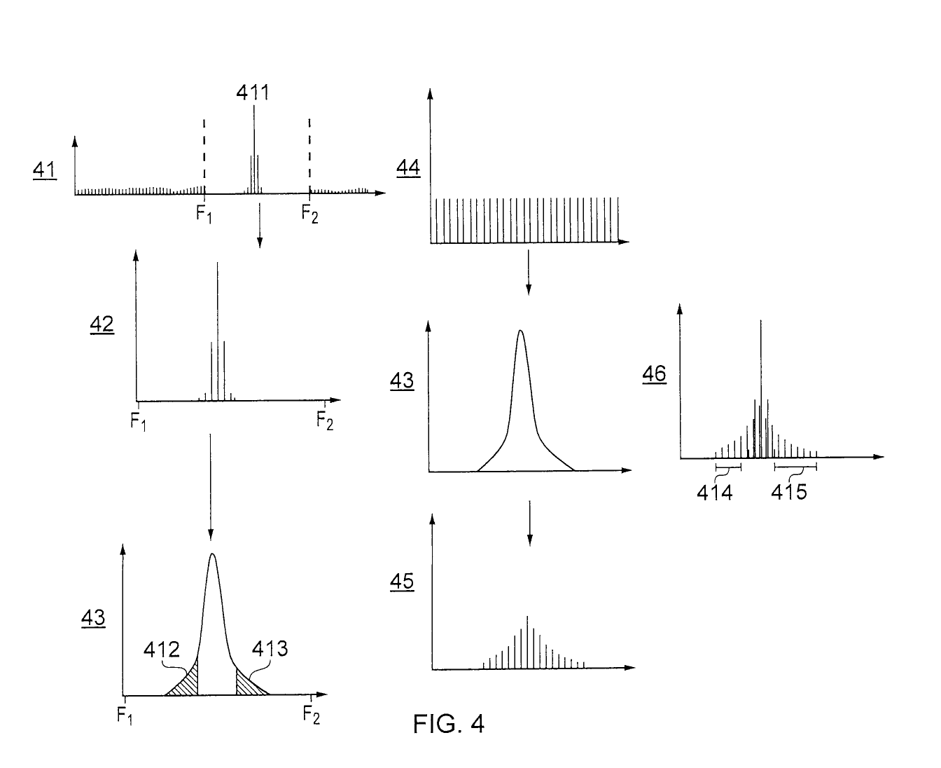

The adaptation of the watermark works well for most audio signals, particularly audio signals comprising part of a cinematic audio track. However, the system shown in FIG. 2 has a problem. The system of FIG. 2 does not successfully mask the presence of a watermark in an audio signal if the audio signal contains prominent frequency components over a narrow range of frequencies (the HAS may mask a narrow range of frequencies but this range can vary with frequency and level and is also asymmetric). Such frequencies may arise in a recording of the sound made by a flute for example. This problem is illustrated in FIG. 4 which shows the frequency spectrum of various signals being processed by the apparatus shown in FIG. 1 but where the audio data unit contains prominent frequency components over a narrow range of frequencies. This is shown in a first graph 41. The range of such frequencies may be, for example, significantly less than the bandwidth of the envelope follower filters 22, 23, 24, 25. Furthermore such frequencies may be ±7.5% of the centre frequency of the input audio signal. The part 411 of the audio data block between the dotted lines represents one of the bands into which the band filter 21 divides the input audio block. As can be seen, this frequency band contains the part of the audio data unit with the prominent frequency components over a narrow range of frequencies. A second graph 42 shows the frequency spectrum of the corresponding band divided block 411 of the audio signal after it has been filtered by the first band filter 21. As before, the band divided block 42 is input into one of the envelope follower filters 22, 23, 24, 25. A third graph 43 shows the frequency spectrum of the output of the envelope follower filter. Due to the response of the filter, some spreading beyond the envelope of the input signal is inevitable. The spreading is indicated on the frequency spectrum of the output of the envelope filter 43 by the shaded regions 412, 413. In order to aid clarity, the cut-off frequency F₁ and F₂ of the band filter 21 have been indicated on the first, second and third graph 41, 42, 43. The result of the spreading of the frequency spectrum output of the envelope filter 43 is that when the envelope filter output 43 is multiplied with the corresponding portion of the band divided watermark block in the time domain (shown in a fourth graph 44 in the frequency domain), the resultant adapted watermark, (shown in a fifth graph 45 in the frequency domain), includes frequencies which extend beyond those found in the band divided block 42. Therefore, when the watermark and audio data unit are combined, as shown in graph 46, the spreading produces additional frequency components 414, 415 of the watermark which are not masked by the audio signal. These unmasked frequency components may be perceptible by the HAS.

This problem could be addressed by using a greater number of narrower envelope follower filters to mitigate the spreading. However, this would require more processor intensive filtering and could also introduce unwanted filter artefacts into the output of the envelope follower filters. Instead, in accordance with embodiments of the present invention, a problematic stimulus is detected, such as high level, narrow band signal and subsequently the overall gain applied to the watermark is reduced for the duration of that stimulus to a level whereby the watermark is imperceptible.

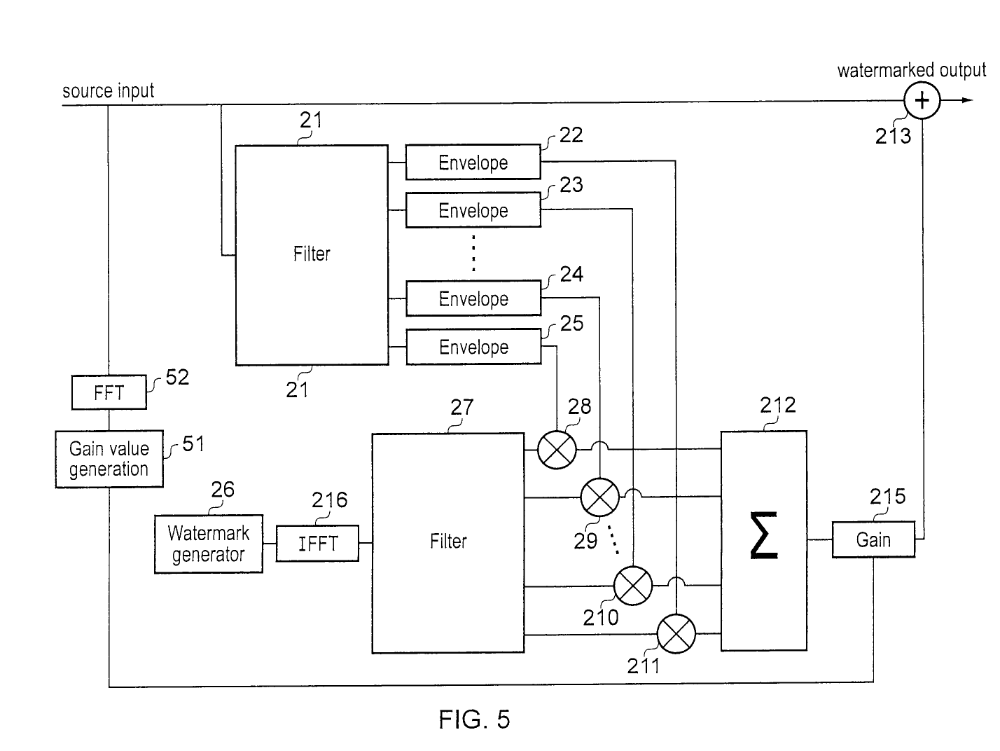

FIG. 5 provides a schematic diagram of a watermarking unit arranged in accordance with the present invention. The watermarking unit is similar to that shown in FIG. 2 except that it includes a FFT unit 52 which transforms the input audio block into a frequency domain FFT block and a gain value generator 51 which controls the amount of gain applied by the gain amplifier 215 to the watermark. The reader is referred to the relevant passages of the description of FIG. 2 for details of how the common elements operate. The gain value generator 215 analyses characteristics of the FFT version of the input audio block; in other words the block into which the watermark is currently being embedded. If narrow band content is detected which is unlikely to mask an embedded watermark successfully, the gain value generator sends a signal to the gain amplifier 215 to reduce the gain applied to the watermark. This drops the level and thus the perceptibility of the embedded watermark.

The following describes the analysis which is performed by the gain value generator 51 on the input audio block currently being watermarked.

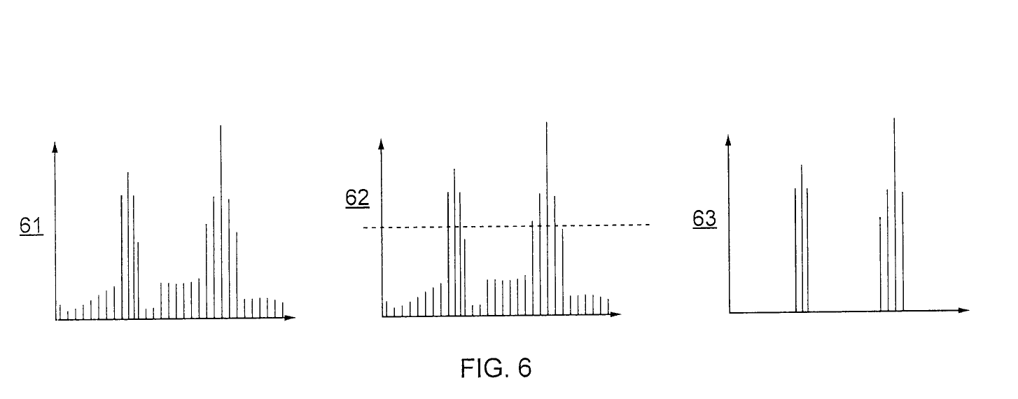

The first step in the process is to acquire the information from the FFT version of the input audio block to determine if the source data is likely to produce unwanted spreading in the envelope follower filter. The gain value generator 51 includes a gate which is used to remove all but the main peaks in the FFT block. This concept is illustrated in FIG. 6. FIG. 6 shows a first graph 61 of a signal comprising the FFT block. A gate is then applied to the signal as shown in a second graph 62. The level at which the gate is set is determined by various properties of the signal and parameters of the gate itself. These properties and parameters (which are discussed below), are chosen so as to isolate frequency components of the FFT block which will be difficult to mask as described above. A third graph 63 shows the signal after it has been processed by the gate. As can be seen, all frequencies below the set level of the gate have been reduced to zero. In the example shown in the third graph 63, this leaves two peaks. These peaks correspond to two narrow band components of the audio signal which are shown in the first graph 61.

In one embodiment the audio signal comprises a 2048 sample block of FFT data at a sampling rate of a quarter that at which the audio signal is sampled and the gate reduces to zero any frequency with an amplitude of less than five times the mean of the whole FFT block. In addition, a lower limit (for example approximately −40 dB) is applied to the mean, whereby if the mean drops below this value then the entire block is reduced to zero to avoid gain reduction caused by for example, alias components introduced during the down sampling. After the gating, all the significant narrow band frequency components of the audio signal are revealed as discernable peaks. The peaks of the gated spectrum 63 are then analysed. The analysis includes the collection of the following values:
Peak number: An integer index number attributed to each peak for identification purposes
Peak energy: A value indicating the total energy contained within each peak, in other words the sum of all the sample values in that peak.
Peak width: The width of each peak in samples.
Peak start location: A value indicating where each peak starts, for example the sample in the FFT block that the peak starts at.
Peak centre location: A value indicating where the highest point of each peak is, for example the sample in the FFT with the most energy within the peak.

From this data the energy of the two largest peaks present in the audio data can be calculated along with their centre locations. In some embodiments if the peak energy of the largest peak is more than 9 dB greater than peak energy of the second largest peak, then the second largest peak is reduced to zero. After this the remaining spectral energy can be calculated as the sum of peak energy values in the analysis data minus the two largest peaks (after the second largest peak has been adjusted as described above).

To determine whether the gain value generator 51 is to apply a gain reduction to the watermark, the peak data is analysed to determine if it satisfies further criteria. For example if one or more of the following conditions are met, a gain reduction is applied to the watermark:
If there is only one peak remaining after the audio signal has been gated;
If the energy of the largest peak is double the remaining spectral energy in the gated audio signal;
If the energy of the largest peak is greater than half the remaining spectral energy in the gated audio signal and is greater than a critical range lower limit, for example 700 Hz;
If the energy of the second largest peak is greater than a proportion, for example 30 percent, of the remaining spectral energy of the gated audio signal and is greater than the critical range lower limit, for example 700 Hz.

In other words, it is possible to analyse the energy distribution of the peaks above the threshold and compare this value with the energy of the input audio signal. As a result of this comparison, the gain of the watermark is adjusted.

If none of the aforementioned criteria have been met, in other words it is determined that there is no need to reduce the level of the watermark, then the gain value generator 61 sets the gain value to unity. However, the gain value may not instantly be set to unity, rather it is increased as per a maximum transition rate discussed below.

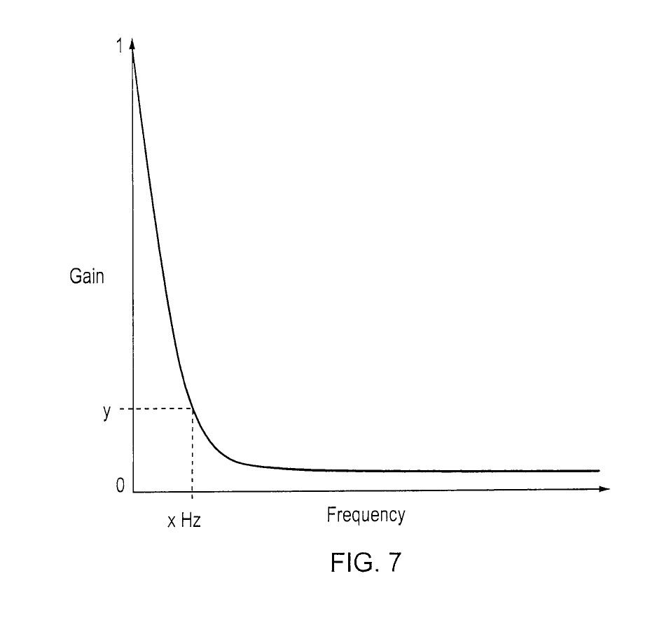

Assuming the previously mentioned test criteria have determined a gain reduction is necessary, the next step is to determine the amount by which the watermark will be reduced by the gain amplifier 215. The gain reduction is calculated based on a predetermined gain reduction curve. As will be understood, the HAS is able to detect certain frequencies better than others. Therefore the gain reduction curve may be derived empirically, for example by conducting listening tests to determine the threshold of watermark audibility at a number of fixed frequencies. The gain reduction for frequencies between the fixed frequencies can be identified using linear interpolation. FIG. 7 illustrates an example gain reduction curve. In order to determine the gain reduction, the frequency at which the largest peak exists is identified and a corresponding gain value determined from the gain curve. For example, as shown in FIG. 7, if the largest peak exists at x Hz, then a gain reduction of y is identified.

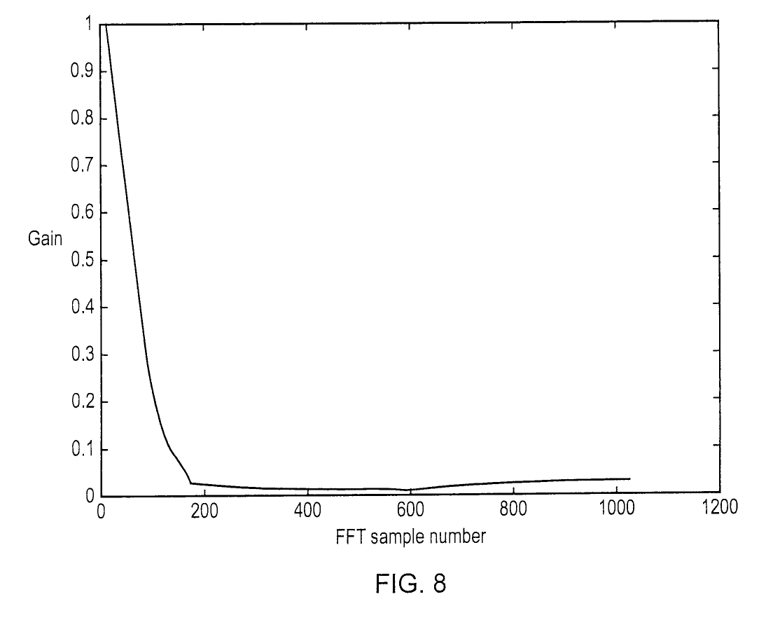

FIG. 8 shows a more specific example of a gain reduction curve. The graph in FIG. 8 shows the gain reduction values in regard to peak frequency in terms of FFT sample number. This curve only specifies up to the Nyquist frequency of the FFT sampled signal.

The gain value is calculated once every time each FFT block is processed. In some embodiments a maximum transition rate can be set which limits the change of the gain on a block by block basis. For example, a maximum gain transition rate of 0.11 (the gain value produced by the gain value generator ranging from 0 to 1) per block may be set. As will be appreciated, it may take multiple blocks to reach the new gain value. In addition, the gain value calculated for a latest block will override any gain value established for a previous block.

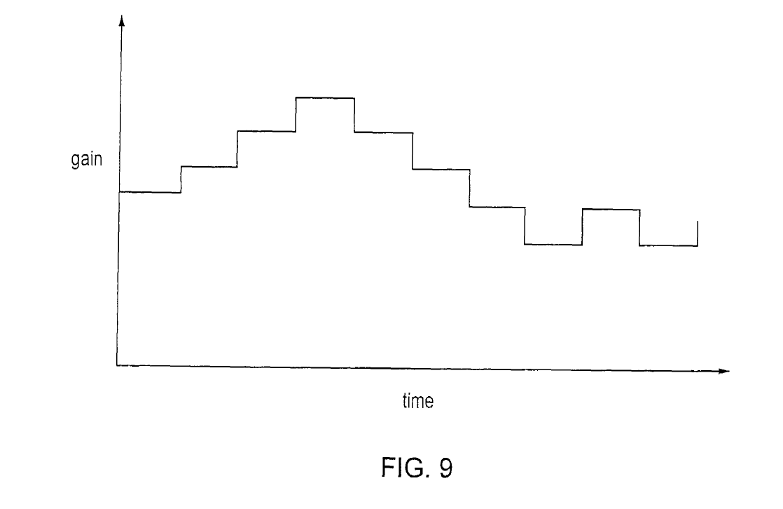

As the gain value output by the gain value generator 51 is calculated on a block by block basis, this means that the change in gain may comprise a series of discrete stepped values. This is shown in FIG. 9. Such abrupt stepping in gain may itself be audible and thus introduce unwanted noise or distortion into the watermarked audio signal. Therefore, in some embodiments, smoothing is applied to this gain change. In the embodiment shown in FIG. 5, this smoothing is undertaken in the gain value generation unit 51, although the invention is not so limited.

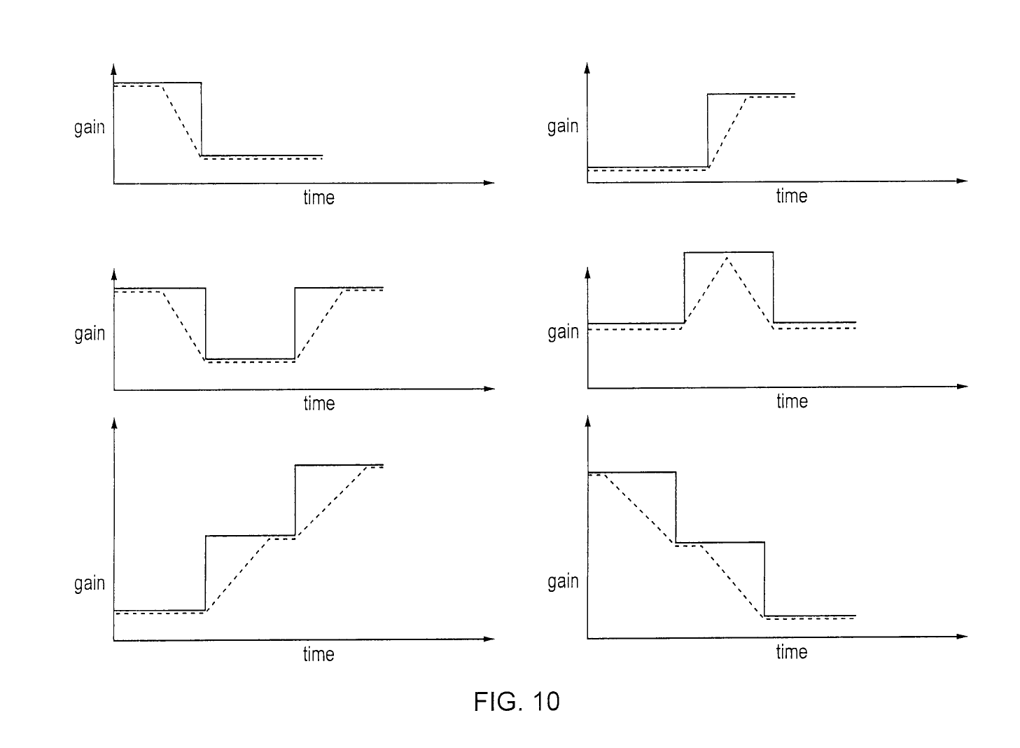

FIG. 10 illustrates some example smoothing interpolations which can be applied to the output of the gain value generator 51 to minimise the likely audibility of the embedded watermark. As can be seen in FIG. 10, the smoothed gain change signal (the broken line) is arranged such that gain change transitions only ever lie within the stepped gain change blocks. This ensures that any transition in watermark gain is never over the gain value determined by the gain value generator 61 and thus ensures that audible components are not added to the watermark by the smoothing of the watermark signal.

The smoothing shown in FIG. 10 requires that three consecutive gain change values; namely that for the previous, current and next FFT block, are known. Therefore, there may be a block delay placed between the first band filter 21 and the FFT frame input. However, in some embodiments the watermarking unit shown in FIG. 5 may be implemented in hardware using a “pipeline” architecture in which no extra delay is required. In one embodiment, the embedding of the watermark can be split into 3 stages (i.e. three pipelines) for sequential processing of data. For example if a third pipeline is processing the “current” input audio block, a second pipeline will be processing a “future” input audio block and so on. When a new input audio block arrives, the pipelines shift relevant data to the next corresponding pipeline.

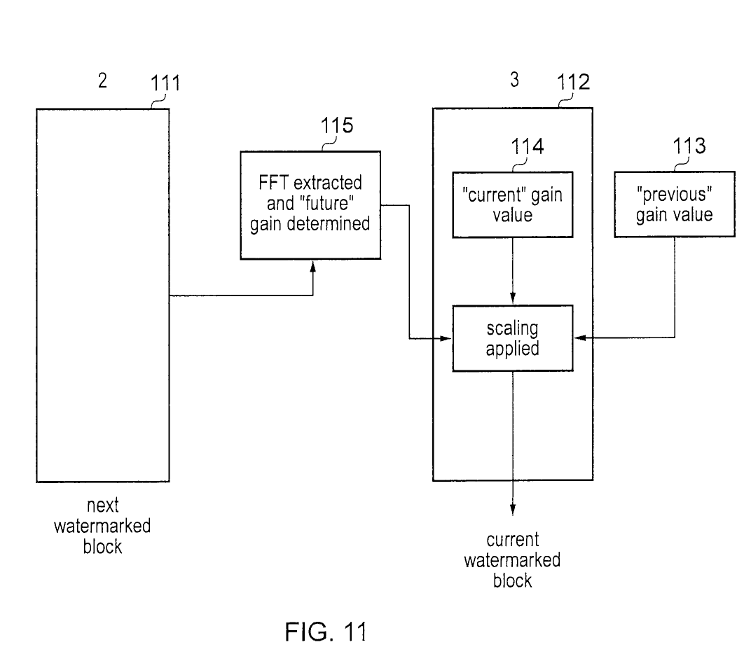

As explained above, in order to realise the smoothing interpolation patterns in FIG. 10, the previous, current and future gain values must be known. FIG. 11 illustrates the second pipeline 111 and the third pipeline 112 from an example embodiment comprising a pipeline architecture. As can be seen the gain value for the “future” block of data (output from the second pipeline 112) is taken by extracting the FFT data from the second pipeline and applying to it the analysis described above to determine a gain value. The third pipeline is arranged such that the third pipeline 112 has access to the “previous” gain value 113 and “current” gain value 114 (calculated previously) and the “future” gain value 115. These values can therefore be combined in the third pipeline 112 to generate a smoothed gain value.

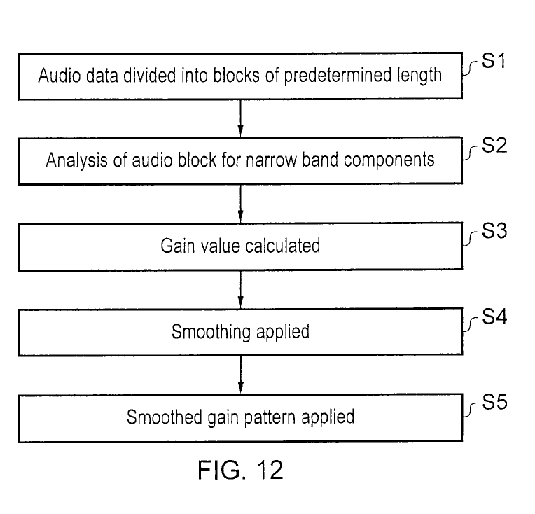

FIG. 12 provides a flow chart summarising steps included in embodiments of the present invention. At step S1 the audio data is divided into units of a predetermined length. At step S2 the resulting input audio blocks are sequentially analysed for narrow band components in the audio signal which may be unable to mask an adapted watermark. At step S3 a gain value is generated based on the properties of any narrow band components identified in step S2. In step S4, the gain value is smoothed to reduce the perceptibility of the gain changes applied to the watermark. As described above, this may take into account previous and future gain values. At step S5 the smoothed gain pattern is applied to the watermark which is embedded in the original audio signal.

Various modifications may be made to the embodiments herein before described. Although embodiments of the invention have been described in terms of a watermarking unit and a pipeline architecture, other implementations are also envisaged. For example the watermarking process could be executed on a computer. The computer could be arranged to implement the present invention by being programmed by a computer program stored on a storage medium, the storage medium containing instructions for carrying out the invention on the computer.

Furthermore, the present invention is not necessarily restricted to use within the context of digital cinema. The invention could be used in any suitable application in which there is a requirement to insert a watermark in audio content.

We claim:

1. An apparatus for embedding a watermark in an audio signal, the apparatus comprising:
an input operable to receive the audio signal;
a watermark adapting unit operable to receive the watermark from a watermark generating unit and adapt the profile of the frequency spectrum of the watermark to correspond to the profile of the frequency spectrum of the input audio signal, and
a watermark embedder operable to embed the adapted watermark in the audio signal, the watermark embedder including a watermark gain amplifier operable to apply a gain to the watermark before the watermark is embedded in the audio signal in accordance with a gain signal generated by a watermark gain value generator, wherein
the watermark gain value generator is operable to adjust the gain applied to the watermark, the gain being determined in accordance with the presence of component of at least one peak having an amplitude above a threshold.

2. An apparatus according to claim 1, wherein the frequency range of the or each peak is such that the peak would cause spreading in the input audio signal such that the watermark in the watermark embedded audio signal is audible to the human ear and if such a peak or peaks are detected, the watermark gain value generator is operable to modify the gain signal such that the gain applied to the watermark by the watermark gain amplifier is reduced.

3. An apparatus according to claim 1 comprising a plurality of envelope filters, each filter being operable to receive the input audio signal and to output an envelope signal corresponding to the distribution of energy across a subset of the frequency spectrum of the input audio signal, each subset being different for each filter.

4. An apparatus according to claim 1, wherein the gain signal is determined by a predetermined gain curve, the gain curve defining the gain signal in dependence of the frequency at which the amplitude of the component peak is largest.

5. An apparatus according to any claim 1, wherein the transition from a first value of gain signal to a second value of gain signal is made incrementally, each increment being of a predetermined value and a predetermined length of time in duration.

6. An apparatus according to claim 5, wherein the increments are one of either a stepped increment or a gradational increment.

7. An apparatus according to claim 1, wherein the watermark gain value generator is further operable to determine the gain in accordance with a comparison between the energy contained in the peak or peaks above the threshold and the energy in the input audio signal.

8. A digital cinema projector comprising:
a decoder for decoding audio data from a data source;
a watermarking apparatus according to claim 1 for inserting a watermark into the audio data; and
a unit for outputting the watermarked audio data.

9. A method of embedding a watermark in an audio signal, the method comprising:
receiving the audio signal;
receiving the watermark from a watermark generating unit and adapting the profile of the frequency spectrum of the watermark to correspond to the profile of the frequency spectrum of the input audio signal, and
embedding the adapted watermark in the audio signal, wherein, before embedding in the audio signal, a gain is applied to the watermark before the watermark is embedded in the audio signal in accordance with a gain signal, wherein
the gain is determined in accordance with the presence of component of at least one peak having an amplitude above a threshold.

10. A method according to claim 9, wherein the frequency range of the or each peak is such that the peak would cause spreading in the input audio signal such that the watermark in the watermark embedded audio signal is audible to the human ear and if such a peak or peaks are detected, the gain signal is modified such that the gain applied to the watermark is reduced.

11. A method according to claim 9 comprising providing a plurality of envelope filters, each filter being operable to receive the input audio signal and to output an envelope signal corresponding to the distribution of energy across a subset of the frequency spectrum of the input audio signal, each subset being different for each filter.

12. A method according to claim 9, wherein the gain signal is determined by a predetermined gain curve, the gain curve defining the gain signal in dependence of the frequency at which the amplitude of the component peak is largest.

13. A method according to claim 9, wherein the transition from a first value of gain signal to a second value of gain signal is made incrementally, each increment being of a predetermined value and a predetermined length of time in duration.

14. A method according to claim 13, wherein the increments are one of either a stepped increment or a gradational increment.

15. A method according to claim 9, comprising determining the gain in accordance with a comparison between the energy contained in the peak or peaks above the threshold and the energy in the input audio signal.

16. A computer program containing computer readable instructions which, when loaded onto a computer, configure the computer to perform a method according to claim 9.

17. A storage medium configured to store a computer program according to claim 16 therein or thereon.
